(19) United States
(12) Patent Application Publication
(10) Pub. No.: US 2020/0041668 A1
(43) Pub. Date: Feb. 6, 2020

(54) Method and System for Directional Radiation Detection

(71) Applicant: Kai Kaletsch, Saskatoon (CA)

(72) Inventor: Kai Kaletsch, Saskatoon (CA)

(21) Appl. No.: 16/339,797

(22) PCT Filed: Feb. 14, 2017
(86) PCT No.: PCT/CA2017/050176

§ 371 Date: Apr. 5, 2019

(51) Int. Cl. G01T 1/29; G01T 7/00

(52) U.S. Cl. CPC G01T 1/2907; G01T 7/00

(57) ABSTRACT

A method and system for directional radiation detection. Two or more radiation detectors are attached to a user's body and the body acts to attenuate radiation passing through the body, such that radiation striking a detector without first passing through the body has a greater intensity than radiation striking a detector after passing through the user. Intensity differences between radiation received at different detectors is thereby used to determine a direction from the user to the radiation source.

### FIELD OF THE INVENTION

The present invention relates to radiation detection methods and systems, and more particularly to directional radiation detection methods and systems.

### BACKGROUND OF THE INVENTION

It is known in the art to provide equipment for detecting ambient nuclear radiation levels, including personal-use devices that can be mounted on or carried by a user. Such equipment provides the benefit of identifying and usually quantifying the nuclear radiation level in an area where the user is located, which can be of particular value if the user is in a location susceptible to potentially dangerous radiation exposure. As the equipment can provide an early warning of hazardous radiation levels, this allows the user to vacate the location or don suitable protective gear.

It is also known in the art to employ equipment and techniques that both detect ambient radiation levels and give an indication of the general location of the radiation source by means of a direction determination. Examples include:
Trial-and-error techniques which involve physically moving conventional radiation detectors until the highest radiation intensity is detected. See for example Patent Cooperation Treaty Application No. PCT/US2006/049589 to Zillner et al.
Shielding can be added to a radiation detector to preferentially block radiation from certain directions, allowing access to the detector from only a single direction. By preferentially absorbing photons from certain directions or reducing their energy, a directional indication is determined.
Physical mechanisms other than simple shielding, such as coincidence counting, may be employed in the equipment. One example is U.S. patent application Ser. No. 12/850,851 to Gueorguiev et al.

By using a directional indication technique, a user can not only identify elevated ambient radiation levels but also determine an approximate location of the radiation source, thereby potentially affording an opportunity to either actively address the radiation source or avoid it.

However, most prior art techniques suffer from significant disadvantages. For example:
Conventional solutions use shielding composed of lead or similar massive materials for shielding to be effective.
Methods relying on other mechanisms, such as coincidence counting techniques, are usually complicated, have low sensitivity and are relatively expensive to implement.
Prior art techniques that involve using one or more radiation detectors to identify the direction of greatest radiation intensity are trial-and-error techniques. These techniques may expose the user to the radiation for an unnecessary length of time while the sweep or triangulation is taking place.

It is therefore clear that the art would benefit from a radiation detection method and system that reduces or eliminates heavy, bulky shielding, while providing directional information in a timely manner that does not entail unnecessary radiation exposure for the user.

### SUMMARY OF THE INVENTION

According to a first aspect of the present invention there is provided a method for determining direction from a user to a radiation source, the method comprising the steps of:
a. positioning two radiation detectors on the user's body, the radiation detectors on opposite sides of the user's body;
b. receiving radiation from the radiation source at each of the two radiation detectors;
c. transmitting data from each of the radiation detectors indicative of intensity of the radiation received at each of the radiation detectors;
d. comparing the data from the radiation detectors; and
e. determining the direction to the radiation source based on the comparing of the data.

According to a second aspect of the present invention there is provided a method for determining direction to a radiation source, the method comprising the steps of:
a. positioning a plurality of radiation detectors on a user's body, the radiation detectors spaced around the user's body;
b. receiving radiation from the radiation source at each of the radiation detectors;
c. transmitting data from the detectors indicative of intensity of the radiation received at each of the radiation detectors;
d. comparing the data from the radiation detectors; and
e. determining the direction to the radiation source based on the comparing of the data.

In some exemplary embodiments of methods according to the present invention where two radiation detectors are employed, the radiation detectors are positioned on the front and back of the user's torso and are attached to the user's clothing. The step of transmitting the data preferably comprises communicating the data to processing means, the processing means configured to perform the steps of comparing the data and determining the direction to the radiation source. The processing means most preferably comprise compass functionality, wherein the step of determining the direction to the radiation source comprises correlating a highest intensity signal with a compass direction. Part of the user's body is preferably positioned between the radiation source and one of the radiation detectors, in which case the method comprises allowing a portion of the radiation to pass from the radiation source through the user's body to that radiation detector, such that the radiation received at that radiation detector is attenuated. The differences in the radiation received by the radiation detectors due to attenuation therefore enables determining the direction to the radiation source, the data indicating greater (less- or non-attenuated) radiation being from the radiation detector directed generally toward the radiation source. The step of determining the direction to the radiation source preferably comprises identifying the radiation detector associated with a larger radiation intensity as being directed generally toward the radiation source. Exemplary methods preferably comprise the further step of providing a visual indicator of the direction to the radiation source, with the further step after step d. of converting the compared data to a visual indicator of radiation intensity and further comprising the step of providing a visual indicator for radiation intensity level reflecting user exposure risk. Exemplary methods further comprise the step of communicating data to an offsite monitoring location for the radiation intensity; when location of the radiation source is determined, the step of communicating data includes data reflecting location of the radiation source. Where only two radiation detectors have been used, preferred methods include the step of rotating the user's body to obtain data from a plurality of orientations with respect to location of the radiation source.

In some exemplary embodiments of methods according to the present invention where a plurality of radiation detectors are employed, the radiation detectors are preferably spaced around the user's body and attached to the user's clothing. The user's body is positioned at least partly between the radiation source and some of the radiation detectors, wherein the preferred method comprises allowing a portion of the radiation to pass from the radiation source, through the user's body to those radiation detectors such that the radiation received at those radiation detectors is attenuated. The differences in the radiation intensities received by the radiation detectors due to attenuation then enables determining the direction to the radiation source, the greater radiation intensity being from the radiation detectors directed generally toward the radiation source.

According to a third aspect of the present invention there is provided a system for determining direction to a radiation source, the system comprising:

two radiation detectors capable of detecting radiation intensity;
attachment means for attaching the two radiation detectors to opposite sides of a user's body; processing means;
means for transmitting data indicative of radiation intensity from each of the two radiation detectors to the processing means;
the processing means configured to compare the data transmitted from the two radiation detectors; and
the processing means further configured to determine the direction to the radiation source based on the comparison of the transmitted data.

The processing means preferably comprise a computing device selected from the group consisting of smartphones, tablet computers and laptop computers. The means for transmitting the data can be either a wired or wireless connection between the radiation detectors and the processing means. The processing means are preferably configured to compare the data and determine the direction to the radiation source by software means accessible by the processing means, and the processing means preferably comprise compass functionality such that the processing means can correlate the greatest positive difference in radiation intensities with a compass direction. Exemplary systems preferably comprise display means configured to receive display data from the processing means. The display means preferably display a visual indicator of the direction to the radiation source as determined by the processing means, and a visual indicator of radiation intensity level reflecting user exposure risk as determined by the processing means. The processing means may comprise a computing device having a screen display, and the display means are then the screen display.

Detailed descriptions of exemplary embodiments of the present invention are given in the following. It is to be understood, however, that the invention is not to be construed as being limited to these embodiments.

### BRIEF DESCRIPTION OF THE DRAWINGS

In the accompanying drawings, which illustrate exemplary embodiments of the present invention:

FIG. 1 is a simplified top plan view illustrating a user with smartphone display adjacent a radiation source;

FIG. 2 is a detailed view illustrating an exemplary smartphone display in directional mode;

FIG. 3 is a detailed view illustrating an exemplary smartphone display in dose mode;

FIG. 4 is a detailed view illustrating an exemplary smartphone display in hybrid mode;

FIG. 5 is a detailed view illustrating an exemplary smartphone display showing the Bluetooth scanner tab;

FIG. 6 is a detailed view illustrating an exemplary smartphone display showing the list of connected Bluetooth devices;

FIG. 7 is a detailed view illustrating an exemplary smartphone display showing the settings for the available modes; and

FIG. 8 is a simplified top plan view illustrating a user with four detectors and a smartphone display adjacent a radiation source.

Exemplary embodiments of the present invention will now be described with reference to the accompanying drawings.

### DETAILED DESCRIPTION OF EXEMPLARY EMBODIMENTS

Referring now to the accompanying drawings, exemplary embodiments of the present invention are illustrated. It is to be understood that the illustrated embodiments are exemplary only and other embodiments may properly fall within the scope of the claims.

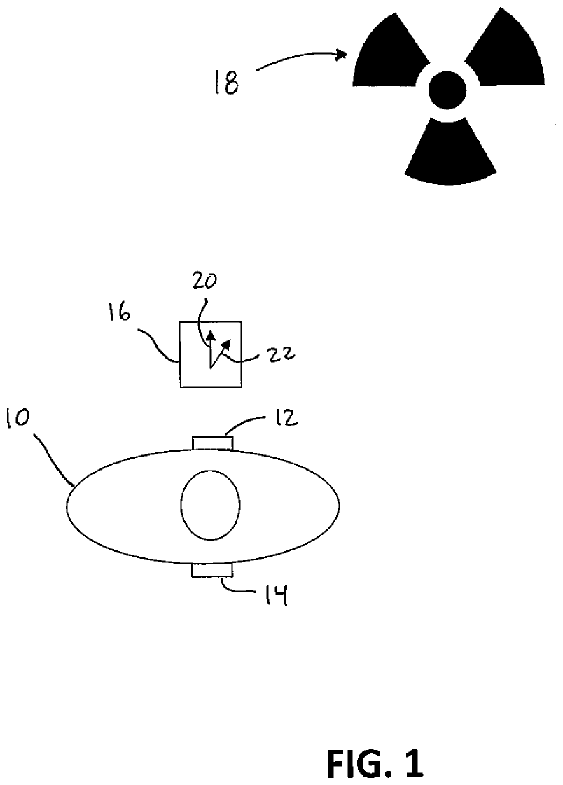

Referring now to FIGS. 1 to 8, exemplary directional radiation detection systems are illustrated. In the illustrated embodiments, a user 10 is provided with two radiation detectors 12, 14. While numerous commercially available detectors could be used with various embodiments of the present invention, their functionality should include the ability to detect the presence of ambient radiation and measure its intensity, and also the ability to communicate data regarding the presence and intensity to a receiver, as described below. One commercially available detector useful for the exemplary embodiments of the present invention is the CT007 device manufactured by the present applicant, Environmental Instruments Canada Inc. (http://www.gammawatch.com/).

Another commercially available detector suitable for use with embodiments of the present invention would be the Kromek D3S (http://www.kromek.com/index.php/component/eshop/d3s?Itemid=147) which is being utilized by the United States Department of Defense's DARPA (Defense Advanced Research Projects Agency) SIGMA project (http://www.darpa.mil/program/sigma).

The user 10 is also provided with a means to receive data from the detectors 12, 14, process the data and display the results. In the exemplary embodiments, this functionality is provided by a smartphone 17 having a display 16. Persons skilled in the art would be able to conceive of other available means of achieving this functionality. This functionality could alternatively be incorporated into one of the detectors, such as the front detector 12.

In an alternative embodiment, not illustrated, smartphones can be used as the radiation detectors, as described in U.S. Pat. No. 8,766,201 to Kaletsch. In that case, the user could attach one smartphone to the back of their torso and hold the other smartphone in front. The two smartphones can communicate wirelessly and no other (dedicated) radiation detectors are thus required. This configuration may be especially advantageous when very high dose rates are encountered, where many dedicated radiation detectors saturate while the smartphone camera-based radiation detectors do not saturate.

The smartphone 17 is used to receive transmitted data from the detectors 12, 14, process the transmitted data, and determine the direction to a radiation source 18, in an exemplary method as set out below. To that end, the smartphone 17 will need to be provided with appropriate software enabling such functionality. The ability to produce such software is within the knowledge of those skilled in the art. The details of such software will accordingly not be described further, but the description will continue with respect to the exemplary method to be practiced using the software-enabled smartphone 17.

Many smartphone devices are equipped with an array of sensors that can be accessed by those skilled in the art. In particular, these sensors can be used to get the directional heading in which the smartphone is pointing. This heading can be based on a magnetic compass and return the smartphone's orientation with respect to magnetic north, or it can be based on a gyroscope and return a heading relative to some initial heading. The gyroscope method is used when the smartphone does not have magnetic sensors (magnetometer) or if the smartphone is being used in an area where the magnetometer readings are unreliable, such as near artificial magnetic fields (e.g., inside a vehicle or a steel building) or at very high or low latitudes near the earth's magnetic poles.

Utilizing these sensors to read directional heading information is known to those skilled in the art and will not be described further. This functionality is used by the exemplary system and method set out herein, as described below.

As can be seen in FIG. 1, the user 10 is provided with two detectors 12, 14. The first detector 12 is attached to the front of the user 10 by a clip, strap or pouch, housed in a shirt or vest pocket, or is simply tucked into the user's shirt, above the belt, or is held in the user's hand, while the second detector 14 is similarly attached to the back of the user 10. Other attachment means will be known to those skilled in the art. As the human body absorbs a degree of the radiation, any detector that is at least partially blocked from the radiation source 18 by the user's body will receive a reduced or attenuated level of radiation when compared to a detector that is not so blocked, and the degree of attenuation will reflect the extent to which the detector is blocked. In the illustrated embodiment, the user 10 is facing in a direction generally toward but slightly to the left of the radiation source 18. In the illustrated case, the first detector 12 will receive radiation from the source 18, not attenuated by passage through the body of the user 10. The second detector 14, in contrast, will receive radiation from the source 18 after the radiation has first passed through the body of the user 10 and has thus been attenuated. Therefore, the radiation received and detected at the first detector 12 will be of a higher intensity than the radiation received and detected at the second detector 14. The different detected intensities can therefore provide the basis for a rough directional determination.

In use, the user 10 would enter an area in the proximity of the radiation source 18. The detectors 12, 14 would then detect the presence of ionizing radiation.

Each of the detectors 12, 14 sends data that includes an indication of the intensity of the radiation level received at that detector (or, alternatively, the data is only sent if a threshold intensity level is achieved). The data can be sent by wired or wireless means to a receiver (such as a smartphone 17 with display 16 according to the exemplary embodiments), which communication means and their application and use would be known to the skilled person. The display 16 can then display both the direction 20 of the user 10 and the calculated direction 22 to the radiation source 18, as illustrated in simplified fashion in FIG. 1.

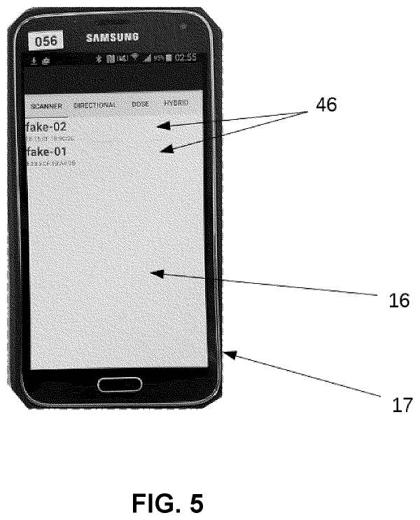

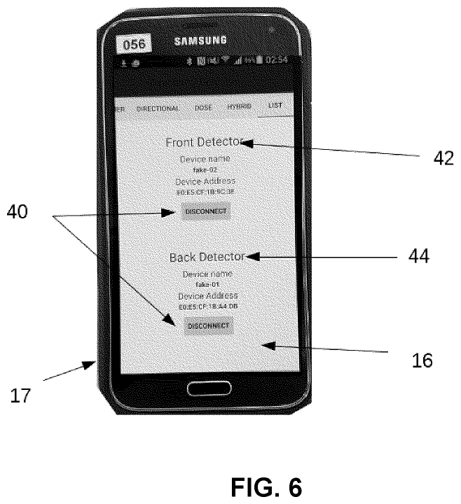

Turning to FIGS. 5 and 6, wireless connection of the detectors is illustrated. FIG. 5 illustrates a screen in which a user is presented with the results 46 of a Bluetooth scan of available devices. These devices, such as radiation detectors, can be selected for connection to the smartphone 17 and use with the enabling software. Once connected, the user can access the screen illustrated in FIG. 6, which shows the connected devices 42, 44 (including information for each device) and allows for disconnection using the buttons 40.

Each of the detectors 12, 14 wirelessly sends information to the smartphone 17 when the enabling software is running and the detectors are connected. In the exemplary embodiment, data that includes the intensity of the radiation level received at each detector 12, 14 is sent to the smartphone 17 every 200 ms and values, corresponding to the radiation intensity received at each detector 12, 14, are stored in arrays. The data is then averaged over a certain time to arrive at the average radiation intensity F received by the front detector 12 and the average radiation intensity B received by the back detector 14. This averaging time can be set by the user 10 or can be calculated by the enabling software, based on statistical accuracy requirements set by the user 10.

When a user 10 enters an area of radiation elevated above a set threshold, the smartphone 17 is configured to emit an alarm tone through operation of the enabling software. Alternatively, the detectors 12, 14 themselves can be configured to sound an alarm when elevated radiation levels are encountered, prompting the user 10 to start the enabling software on the smartphone 17 and connect to the detectors 12, 14.

As described above, the software periodically (every 200 ms in this exemplary embodiment) calculates the average intensity of the radiation received in the front and back detectors 12, 14. These values, F and B respectively, are used to perform further calculations. The results of these calculations are presented to the user 10 on separate displays, as described below.

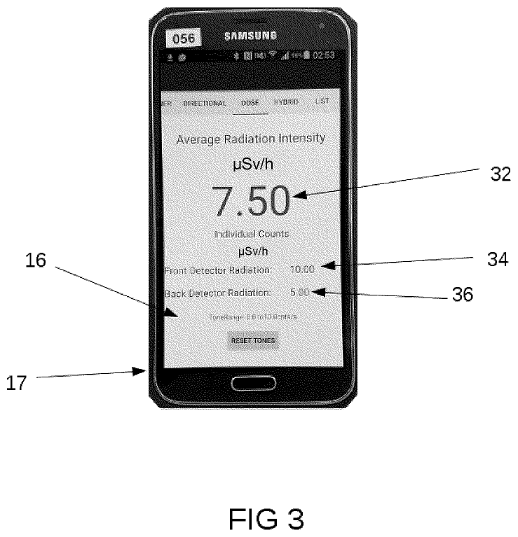

Turning now to FIG. 3, a smartphone 17 is illustrated with a display 16, and a “Dose” screen is illustrated which displays the radiation dose rates 34 and 36 measured by the front and back detectors 12, 14, respectively, and the average dose rate 32 based on the dose rates received by the detectors 12, 14. The average dose rate 32 is determined as follows:

(F+B)/2×CF

where F is the radiation level detected by the front detector 12, B is the radiation level detected by the back detector 14, and CF is a conversion factor that converts between the units used by the detectors and the units of dose rate. For example, the CT007 measures the number of radiation interactions within the sensor in units of counts and dose is measured in Sieverts (Sv). F and B are expressed in counts per second and dose rates are expressed in Sieverts per hour (Sv/h). The conversion factor has units of (Sv/h)/(count/second).

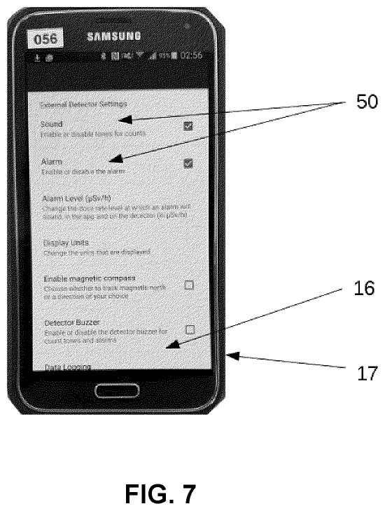

This screen shown in FIG. 3 is analogous to the typical display found on standard radiation measuring instruments. It displays the dose rate in digital form. It may also include a speedometer type analog display and/or colour indicators to help the user interpret the reading. For example, a green background means normal background radiation, yellow means elevated levels, and red means that radiation has reached dangerous levels. The dose rates at which the colour changes are set using settings 50 in the Settings menu of the enabling software, which is illustrated in FIG. 7.

By combining the results of two detectors, the sensitivity or statistical power of the system is increased, compared to using only a single detector.

Typically, the user 10 would look at this FIG. 3 screen first, to see what the dose rate is and whether there is a difference in the rates detected by the front and back detectors 12, 14.

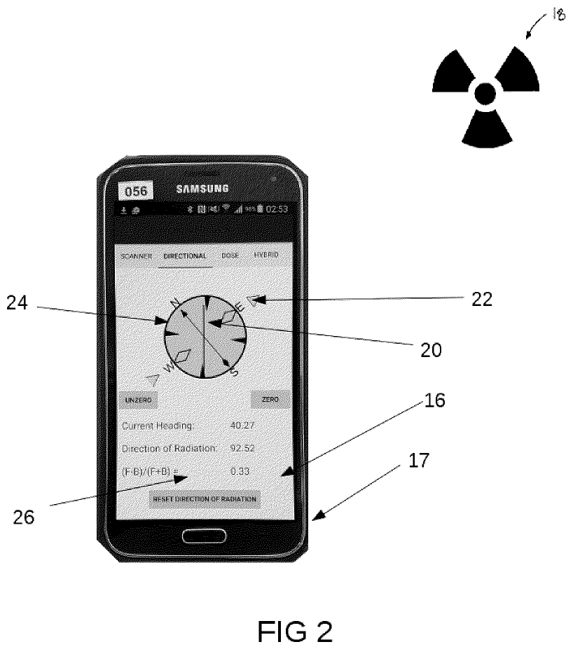

Turning now to FIG. 2, the smartphone 17 display 16 is displaying a “Directional” screen, which helps the user 10 determine the direction of the radiation source 18.

To determine the direction from the user 10 to the radiation source 18, the user 10 preferably holds the smartphone 17 parallel to the line connecting detectors 12, 14 and slowly turns around. The software-enabled smartphone 17 then calculates the result of the following formula:

(F−B)/(F+B)

and displays it on the “Directional” screen at area 26.

(F−B) measures the difference in the radiation level between the front and back detectors 12, 14. Dividing by (F+B) normalizes the result and makes it independent of the overall radiation level. This is useful if the radiation level varies in time, for example, if the source is behind shielding that changes in time, such as moving vehicles.

The larger the value of (F−B)/(F+B), the more directly the user's body is facing toward the source 18.

Whenever the value of (F−B)/(F+B) is calculated (for example every 200 ms), the software-enabled smartphone 17 also acquires directional heading information from the smartphone's sensors. If the value of (F−B)/(F+B) is greater than the maximum value of (F−B)/(F+B) that has been recorded up to that time, then the heading is stored in a variable, overwriting the value that was previously stored in the variable. That variable therefore stores the heading that corresponds to the maximum value of (F−B)/(F+B), which is the most likely heading of the source 18.

The user 10 can reset the maximum value of (F−B)/(F+B) by tapping on a button shown at the bottom of the display 16 and thus restart the direction search.

The directional screen also shows a graphic 22 indicating the most likely direction to the source 18, as well as a compass dial 24 showing the cardinal directions, and the current heading 20 of the user 10.

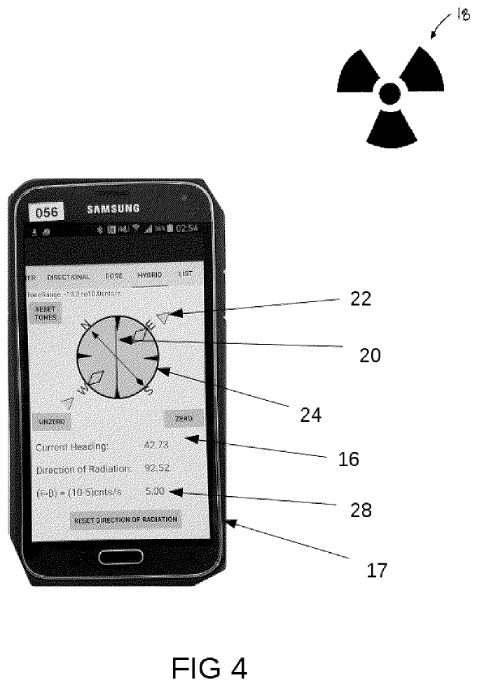

In some situations, such as in many emergency response exercises, the radiation level is not time dependent. In these cases, we do not need to divide the difference in the radiation level between the front and back detectors 12, 14 by their sum. Turning now to FIG. 4, then, a “Hybrid” screen is illustrated which shows the result of the following formula:

(F−B)

The calculated value 28 is displayed on the display 16 of the smartphone 17. An increase in the value of (F−B) could indicate either that the user's body is facing more directly toward the source 18 or that the user 10 is closer to the source 18 (and therefore both F and B are larger) or that there is less shielding between the source 18 and the user 10.

The Hybrid screen may be a more intuitive screen for use in source finding competitions, where the radiation level is not time dependent. The competitor would rotate their torso and move in a way that maximizes F−B. In other words, the competitor wants to be both turning toward the source and moving toward the source in order to find the source.

Audio indicators can also be enabled to provide feedback and the user 10 then does not have to look at the screen 16 and instead can focus on other things. As well, audio can be transmitted from the smartphone 17 to an ear piece. This makes it easy for the user 10 to discreetly and covertly use such embodiments of the present invention to locate radiation sources.

Different audio feedback modes can be made available with embodiments of the present invention, as would be clear to the skilled person, depending on which screen is selected. The audio feedback may not require directional heading information and its use thus may not be dependent on the smartphone's ability to produce heading information. The user can keep the smartphone in a pocket and such an embodiment can be used entirely hands-free.

For example, in the Dose screen illustrated in FIG. 3, the frequency (i.e., number) of tones can be proportional to (F+B). If the frequency of beeps becomes too large (i.e., it would result in a continuous tone, rather than individual beeps), then the proportionality constant between (F+B) and the corresponding number of tones can be automatically changed by the enabling software. This could be made immediately noticeable to the user, with the beep frequency shifting very abruptly. The proportionality constant can also be displayed on the screen 16. The user has the option to reset the proportionality constant by tapping a button.

In the Directional screen illustrated in FIG. 2, the tones would have a different pitch, depending on whether the user is pointing toward the source (i.e. (F−B)/(F+B)>0) or away from the source (i.e. (F−B)/(F+B)<0). A high pitch could be used to indicate pointing toward the source and a low pitch could be used to indicate pointing away from the source.

The frequency (i.e., number) of tones is proportional to the absolute value of (F−B)/(F+B). For example, a value of 0 corresponds to 0 beeps per second and a value of 1 corresponds to 20 beeps per second. Note that, since both F and B are positive, the absolute value of (F−B)/(F+B) is always between 0 and 1.

In the Hybrid screen illustrated in FIG. 4, the audio may provide an indication of the value of (F−B). The audio of the Hybrid screen is similar to the audio of the Directional screen, in that the tones have a different pitch depending on whether the user is pointing toward the source (i.e., (F−B)>0) or away from the source (i.e., (F−B)<0). Similarly to the audio for the Dose screen, the proportionality constant between (F−B) and the corresponding number of tones is changed, to avoid the beeps becoming so frequent that they become a continuous tone.

As the smartphone 17 is provided with wireless communication capability, it can also relay the smartphone's GPS coordinates and the direction to the source 18 to a central monitoring station (not shown). Having a central monitoring station can provide additional advantages. For example, a central monitoring station can gather data from various users and then use that geographically spaced data to triangulate the location of the radiation source 18.

Additional information, such as radiation source composition, may also be gained by capturing the energy spectrum of the received radiation rather than simply the gross counts. Many commercially available radiation detectors, such as the Kromek D3 S can capture the energy spectrum. Spectral information can also be used in the determination of the direction of the source, as is described in U.S. patent application Ser. No. 12/375,918 to Ramsden et al.

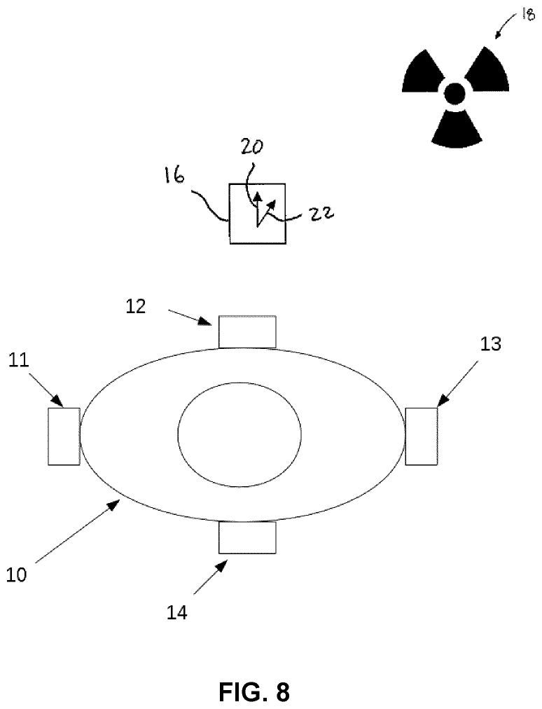

Turning now to FIG. 8, a further exemplary embodiment is illustrated comprising more than two detectors. By adding additional detectors around the user's body, each connected to the receiving/processing unit (the smartphone 17 in the illustrated embodiment), the direction of the source can be found more precisely without the user having to physically turn their torso. The more detectors that are used, the more precisely the direction of the radiation source can be determined.

In FIG. 8 the user 10 is wearing four detectors: a front detector 12, a back detector 14, a detector 11 at the left of the torso and a detector 13 at the right of the torso.

In the illustrated embodiment, radiation emitted by the source 18 does not have to travel through any part of the torso to reach the detectors 12 and 13. The measured radiation intensity at these two detectors 12, 13 is therefore the greatest. To reach the back detector 14, the radiation has to pass directly through the user's torso and is therefore significantly reduced. To reach the left detector 11, the radiation only passes a short distance through the torso and the measured radiation intensity at the left detector 11 is less than at the front and right detectors 12, 13, but greater than at the back detector 14.

From the information that the radiation intensity at the front and right side is the highest, the radiation level at the left is somewhat reduced and the radiation level at the back is the lowest, an appropriate algorithm would conclude that the source is located in front of the user and slightly to the right.

While in the exemplary embodiment the user's body has been presented as comprising a gamma shield, the user's body can also be used as a neutron moderator. If each detector contains two or more radiation sensors with different neutron capture sensitivities, then the relative count rates in each detector can be used to determine if one is dealing with a gamma or neutron source. If the apparent attenuation across the user's body between the neutron capture detectors is significantly different than the non-neutron capture detectors, one can conclude that one is dealing with a neutron source. The neutron capture detector, facing a fast neutron source, will have comparatively few counts since fast neutrons are not captured easily. Once they have passed through the user's body, some neutrons will have slowed and are captured more readily in the detector on the far side of the user's body. The non-neutron capture detectors will respond the opposite way. There will be more fast neutron recoil interactions, as well as gamma interactions, in the detector facing the radiation source.

Those skilled in the art will appreciate that parameters such as the averaging time for observing counts, the scaling factor between counts received and beeps produced, the tone of the beeps, as well as the algorithm used are all subject to optimization and may be user selectable or may be automatically switched by the exemplary software.

Other equations may be used in place of the ones described in the exemplary embodiments, when determining the direction of radiation. The details of such equations fall within the knowledge of those skilled in the art and will not be discussed further.

In the exemplary embodiments of the present invention, the data is transmitted by wireless means and received by a smartphone device, provided with appropriate software and a display. While other computing devices can be used with the present invention, such as a tablet computer, a smartphone is relatively small and lightweight and accordingly meets a perceived need in the art. The equipment required under this exemplary embodiment is therefore limited to two small detectors and a smartphone, which is relatively light compared to prior art systems.

As indicated above, a significant and well-known drawback of conventional directional radiation detection systems is the bulkiness of the equipment due to the presence of shielding, which shielding is often lead-based and relatively heavy. The present invention, in contrast, does not make use of lead-based shielding to enable direction determination. Instead, the present invention makes use of the user's own body to partially shield at least one detector from gamma radiation emitted by the radiation source.

As will be clear to those skilled in the art, embodiments of the present invention can have several advantages over prior art techniques and equipment. For example, the required equipment would typically be at least one order of magnitude less in weight than conventional equipment, and with far less bulk; as one example, each CT007 detector only weighs 55 grams, while some other commercially available directional radiation detectors weigh thousands of grams. Given the simplified equipment requirements and reliance on a software-enabled smartphone, the cost for a directional radiation detection system in accordance with the present invention can also be much more modest than some prior art systems. One significant advantage is that the directional radiation detection system of the present invention can use ordinary personal alarming radiation detectors, so an organization, such as a police department, can get overlapping functionality and utility, the only difference for directional functionality being the use of more than one detector and the use of the necessary software. In the event that a user such as a police officer wishes to engage in directional radiation detection without it being obvious to passersby, the present invention also provides a solution that introduces a novel degree of discretion. Where an embodiment of the present invention employs auditory indicators rather than visual indicators, this may have advantages to law enforcement personnel and first responders in emergency situations, as the hands are kept free. Finally, use of a smartphone introduces advantages around communication functionality, such as the ability to communicate data to a central monitoring facility.

The foregoing is considered as illustrative only of the principles of the invention. Thus, while certain aspects and embodiments of the invention have been described, these have been presented by way of example only and are not intended to limit the scope of the invention. The scope of the claims should not be limited by the exemplary embodiment set forth in the foregoing, but should be given the broadest interpretation consistent with the specification as a whole.

1. A method for determining direction from a user to a radiation source, the method comprising the steps of:
a. positioning two radiation detectors on the user's body, the radiation detectors on opposite sides of the user's body;
b. receiving radiation from the radiation source at each of the two radiation detectors;
c. transmitting data from each of the radiation detectors indicative of intensity of the radiation received at each of the radiation detectors;
d. comparing the data from the radiation detectors; and
e. determining the direction to the radiation source based on the comparing of the data.

2. The method of claim 1 wherein the radiation detectors are positioned on the front and back of the user's torso.

3. The method of claim 1 wherein the radiation detectors are positioned by attaching them to the user's clothing.

4. The method of claim 1 wherein the step of transmitting the data comprises communicating the data to processing means, the processing means configured to perform the steps of comparing the data and determining the direction to the radiation source.

5. The method of claim 1 wherein part of the user's body is positioned between the radiation source and one of the radiation detectors, the method comprising allowing a portion of the radiation to pass from the radiation source through the user's body to that radiation detector such that the radiation received at that radiation detector is attenuated.

6. The method of claim 5 wherein the differences in the radiation received by the radiation detectors due to attenuation enables determining the direction to the radiation source, the data indicating greater radiation being from the radiation detector directed generally toward the radiation source.

7. The method of claim 1 wherein the step of determining the direction to the radiation source comprises identifying the radiation detector associated with a larger radiation intensity as being directed generally toward the radiation source.

8. The method of claim 4 wherein the processing means comprise compass functionality, wherein the step of determining the direction to the radiation source comprises correlating a highest intensity signal with a compass direction.

9. The method of claim 1 comprising the further step of providing a visual indicator of the direction to the radiation source.

10. The method of claim 1 comprising the further step after step d. of converting the compared data to a visual indicator of radiation intensity.

11. The method of claim 10 further comprising the step of providing a visual indicator for radiation intensity level reflecting user exposure risk.

12. The method of claim 1 further comprising the step of communicating data to an offsite monitoring location for the radiation intensity.

13. The method of claim 12 wherein location of the radiation source is determined, wherein the step of communicating data includes data reflecting location of the radiation source.

14. The method of claim 1 further comprising the step of rotating the user's body to obtain data from a plurality of orientations with respect to location of the radiation source.

15. A method for determining direction to a radiation source, the method comprising the steps of:
a. positioning a plurality of radiation detectors on a user's body, the radiation detectors spaced around the user's body;
b. receiving radiation from the radiation source at each of the radiation detectors;
c. transmitting data from each of the radiation detectors indicative of intensity of the radiation received at each of the radiation detectors;
d. comparing the data from the radiation detectors; and
e. determining the direction to the radiation source based on the comparing of the data.

16. The method of claim 15 wherein the radiation detectors are positioned by attaching them to the user's clothing.

17. The method of claim 15 wherein transmitting the data comprises communicating the data to processing means, the processing means configured to perform the steps of comparing the signals and determining the direction to the radiation source.

18. The method of claim 15 wherein the user's body is positioned at least partly between the radiation source and some of the radiation detectors, the method comprising allowing a portion of the radiation to pass from the radiation source through the user's body to those radiation detectors such that the radiation received at those radiation detectors is attenuated.

19. The method of claim 18 wherein the differences in the radiation intensities received by the radiation detectors due to attenuation enables determining the direction to the radiation source, the greater radiation intensity being from the radiation detectors directed generally toward the radiation source.

20. The method of claim 15 wherein the step of determining the direction to the radiation source comprises identifying the radiation detectors associated with larger radiation intensities from the transmitted data as being directed generally toward the radiation source.

21. The method of claim 17 wherein the processing means comprise compass functionality, wherein the step of determining the direction to the radiation source comprises correlating greatest positive difference in counting data with a compass direction.

22. The method of claim 15 comprising the further step of providing a visual indicator of the direction to the radiation source.

23. The method of claim 15 comprising the further step after step d. of converting the compared data to a visual indicator of radiation intensity.

24. The method of claim 23 further comprising the step of providing a visual indicator for radiation intensity level reflecting user exposure risk.

25. The method of claim 15 further comprising the step of communicating data to an offsite monitoring location for the radiation intensity.

26. The method of claim 25 wherein location of the radiation source is determined, wherein the step of communicating data includes data reflecting location of the radiation source.

27. A system for determining direction to a radiation source, the system comprising:
two radiation detectors capable of detecting radiation intensity;
attachment means for attaching the two radiation detectors to opposite sides of a user's body;
processing means;
means for transmitting data indicative of radiation intensity from each of the two radiation detectors to the processing means;
the processing means configured to compare the data transmitted from the two radiation detectors; and
the processing means further configured to determine the direction to the radiation source based on the comparison of the data.

28. The system of claim 27 wherein the processing means comprise a computing device selected from the group consisting of smartphones, tablet computers and laptop computers.

29. The system of claim 27 wherein the means for transmitting the data is a wired connection between the radiation detectors and the processing means.

30. The system of claim 27 wherein the means for communicating the data is a wireless connection between the radiation detectors and the processing means.

31. The system of claim 27 wherein the attachment means are clips configured to attach the radiation detectors to the user's clothing.

32. The system of claim 27 wherein the processing means are configured to compare the transmitted data and determine the direction to the radiation source by software means accessible by the processing means.

33. The system of claim 27 wherein the processing means comprise compass functionality and the processing means can correlate the greatest positive difference in radiation intensity with a compass direction.

34. The system of claim 27 further comprising display means configured to receive data from the processing means.

35. The system of claim 34 wherein the display means displays a visual indicator of the direction to the radiation source as determined by the processing means.

36. The system of claim 34 wherein the display means displays a visual indicator of radiation intensity level reflecting user exposure risk as determined by the processing means.

37. The system of claim 34 wherein the processing means comprise a computing device having a screen display, and the display means are then the screen display.
